(19) United States
(12) Patent Application Publication
(10) Pub. No.: US 2026/0165342 A1
(43) Pub. Date: Jun. 18, 2026

(54) COLD BEVERAGE MAKER

(71) Applicant: Guangdong Welly Electrical Appliances Co., Ltd., Zhongshan (CN)

(72) Inventors: Xiangan Wu, Zhongshan (CN); Linjun Mai, Zhongshan (CN); Yangyang Ma, Zhongshan (CN); Wenzhan Hu, Zhongshan (CN)

(21) Appl. No.: 19/079,609

(22) Filed: Mar. 14, 2025

(30) Foreign Application Priority Data
Dec. 13, 2024 (CN) 202411842325.4

(51) Int. Cl. A23G 9/22; A23G 9/12

(52) U.S. Cl. CPC A23G 9/227; A23G 9/12; A23G 9/224

(57) ABSTRACT

The present disclosure provides a cold beverage maker, including a cabinet, a separation plate, a cold beverage apparatus, and a compressor, where the cold beverage apparatus includes an evaporator, a cold beverage cartridge provided in the evaporator, a stirring member provided in the cold beverage cartridge, and a driving apparatus for driving the stirring member; a display region is provided on a front or a top of the cabinet; a feed region is provided on the top of the cabinet; at the feed region, the top of the cabinet is recessed to form a feed groove; a detachable feed hopper is provided in the feed groove; and the feed hopper communicates with the cold beverage cartridge. The present disclosure is structurally compact and reasonable, and is cleaned conveniently.

### CROSS REFERENCE TO RELATED APPLICATIONS

The present application claims the benefit of Chinese Patent Application No. 2024118423254filed on Dec. 13, 2024, the contents of which are incorporated herein by reference in their entirety.

### TECHNICAL FIELD

The present disclosure relates to the technical field of refrigeration devices, and in particular to a cold beverage maker.

### BACKGROUND

As an efficient, convenient and multifunctional device for making cold beverages, the cold beverage maker has been widely applied to various dining places or home kitchens. Particularly, due to intellectualization of the existing cold beverage maker, more functional devices are accommodated in a cabinet. For the sake of heat dissipation, mounting spaces are reserved for different components. Particularly, the cold beverage maker produces a large amount of heat in work. When intelligent components are added, the high temperature in work is further to be considered.

On the other hand, the existing cold beverage maker generally has an internal cleaning function. However, the feed port can only be cleaned by the hand from the outside. In this condition, the body of the cold beverage maker gets wet inevitably in the cleaning process, and the water flows into the cabinet accidentally.

### SUMMARY

A technical problem to be solved by an embodiment of the present disclosure is to provide a cold beverage maker. The present disclosure is structurally compact and reasonable, and is cleaned conveniently.

In order to solve the above technical problem, an embodiment of the present disclosure provides a cold beverage maker, including a cabinet, a separation plate provided in the cabinet, a cold beverage apparatus for making a cold beverage, and a compressor for refrigerating the cold beverage apparatus, where through the separation plate, the cabinet is internally separated into an upper device space and a lower device space; and the cold beverage apparatus and the compressor are respectively provided in the upper device space and the lower device space;
the cold beverage apparatus includes an evaporator, a cold beverage cartridge provided in the evaporator, a stirring member provided in the cold beverage cartridge, and a driving apparatus for driving the stirring member;
a display region is provided on a front or a top of the cabinet; and a feed region is provided on the top of the cabinet; and
at the feed region, the top of the cabinet is recessed to form a feed groove; a detachable feed hopper is provided in the feed groove; and the feed hopper communicates with the cold beverage cartridge.

As an improvement to the above solution, at the display region, the front or the top of the cabinet inclines upward to form, in the cabinet, a display space for mounting a display screen; and a display port for mounting a display panel is formed at the display region.

As an improvement to the above solution, the upper device space is laterally divided into a refrigerating space and a driving heat dissipating space; and the evaporator and the driving apparatus are respectively provided in the refrigerating space and the driving heat dissipating space; and
on the cabinet, a discharge hole matching with the cold beverage cartridge and an upper heat dissipating port for dissipating heat are respectively formed at a left end and a right end of the upper device space.

As an improvement to the above solution, the separation plate is provided with a communicating region for communicating the upper device space and the lower device space; and a plurality of communicating holes are formed in the communicating region; and
the communicating region corresponds to the driving heat dissipating space.

As an improvement to the above solution, a bracket for supporting the separation plate and a heat exchanger housing for mounting a heat exchanger are respectively provided at two inner sides of the lower device space; and
the bracket and the heat exchanger housing jointly support the separation plate.

As an improvement to the above solution, the heat exchanger provided for the compressor is provided in the heat exchanger housing; a cooling fan is further provided in the heat exchanger housing; and the cooling fan is located under the communicating region.

As an improvement to the above solution, a communicating tube communicating with the cold beverage cartridge is provided on a bottom of the feed groove; and
the feed hopper matches with the feed groove in shape, so as to cover a surface of the feed groove.

As an improvement to the above solution, the evaporator is provided with an insulating housing; a first mounting hole is formed in a sidewall of the insulating housing; and the driving apparatus includes a rotating shaft for driving the stirring member to rotate and a first sealing connection seat;
the cold beverage cartridge is mounted in the insulating housing; a second mounting hole is formed in the cold beverage cartridge; and the rotating shaft rotatably penetrates through the second mounting hole and the first mounting hole;
the first sealing connection seat is connected between the insulating housing and the cold beverage cartridge; the first sealing connection seat is connected to a limiting member; the limiting member is inserted into the second mounting hole; and the limiting member is in sealing connection with the second mounting hole; and
the rotating shaft penetrates through the limiting member; a first sealing member is provided between the rotating shaft and the limiting member; and the first sealing member includes an inner ring in sealing connection with the rotating shaft, and an outer ring in clearance fit with the limiting member.

As an improvement to the above solution, an end of the limiting member inserted into the second mounting hole is provided with an extended boss; and the extended boss includes an outer ring abutting against an inner sidewall of the cold beverage cartridge through a sealing gasket in a sealing manner, and an inner ring connected to the outer ring of the first sealing member; and
a side of the first sealing member away from the cold beverage cartridge is provided with a second sealing member; and an inner ring of the second sealing member is in sealing connection with the rotating shaft.

As an improvement to the above solution, the driving apparatus further includes a second sealing connection seat provided on an outer sidewall of the insulating housing; the second sealing connection seat is detachably connected to the first sealing connection seat; and a size of the second sealing connection seat is greater than a size of the first mounting hole;
a side of the second sealing connection seat close to the first sealing connection seat is provided with a sealing boss; an insertion hole is formed in the first sealing connection seat; the sealing boss is inserted into the insertion hole; and an inner side of the sealing boss abuts against the second sealing member; and
a first mounting groove is formed in the outer sidewall of the insulating housing; and the second sealing connection seat is embedded into the first mounting groove.

As an improvement to the above solution, the driving apparatus further includes a driving connection seat; the driving connection seat includes one side connected to the second sealing connection seat, and the other side connected to a driving member; a transmission set is provided in the driving connection seat; an output shaft of the driving member is rotatably connected to a driving end of the transmission set; and a driven end of the transmission set is rotatably connected to the rotating shaft; and
a second mounting groove is formed at a side of the second sealing connection seat away from the insulating housing; and one side of the driving connection seat is embedded into the second mounting groove.

As an improvement to the above solution, a rabbet of the feed groove extends upward to form an extension edge of a preset length, thereby forming a guide channel housing communicating with the feed groove.

As an improvement to the above solution, the cold beverage maker is an ice cream maker or a smoothie maker or a multifunctional machine for making ice cream and smoothie.

The present disclosure has the following beneficial effects:

The cold beverage maker provided by the embodiment of the present disclosure includes the cabinet, the separation plate provided in the cabinet, the cold beverage apparatus for making the cold beverage, and the compressor for refrigerating the cold beverage apparatus. Through the separation plate, the cabinet is internally separated into the upper device space and the lower device space. The cold beverage apparatus and the compressor are respectively provided in the upper device space and the lower device space. The cold beverage apparatus includes the evaporator, the cold beverage cartridge provided in the evaporator, the stirring member provided in the cold beverage cartridge, and the driving apparatus for driving the stirring member. With the separation plate, the present disclosure can separate a cold working space and a hot working space.

The display region is provided on the front or the top of the cabinet. The feed region is provided on the top of the cabinet. At the feed region, the top of the cabinet is recessed to form the feed groove. The detachable feed hopper is provided in the feed groove. The feed hopper communicates with the cold beverage cartridge. After use, only the feed hopper rather than the whole device is cleaned, thereby being convenient and quick.

### BRIEF DESCRIPTION OF THE DRAWINGS

FIG. 1 is a perspective view of a cold beverage maker according to the present disclosure;

FIG. 2 is a schematic sectional view of a cold beverage maker according to the present disclosure;

FIG. 3 is a schematic perspective view of a cold beverage apparatus according to the present disclosure;

FIG. 4 is a schematic exploded view of a cold beverage apparatus according to the present disclosure;

FIG. 5 is a schematic view of connection between a first sealing connection seat and a second sealing connection seat according to the present disclosure;

FIG. 6 is a schematic sectional view of a cold beverage apparatus according to the present disclosure;

FIG. 7 is an enlarged view of A shown in FIG. 6; and

FIG. 8 is a schematic perspective view of an insulating housing according to the present disclosure.

### DETAILED DESCRIPTION

In order to make the objectives, technical solutions, and advantages of the present disclosure more clear, the present disclosure will be further described in detail below with reference to the accompanying drawings.

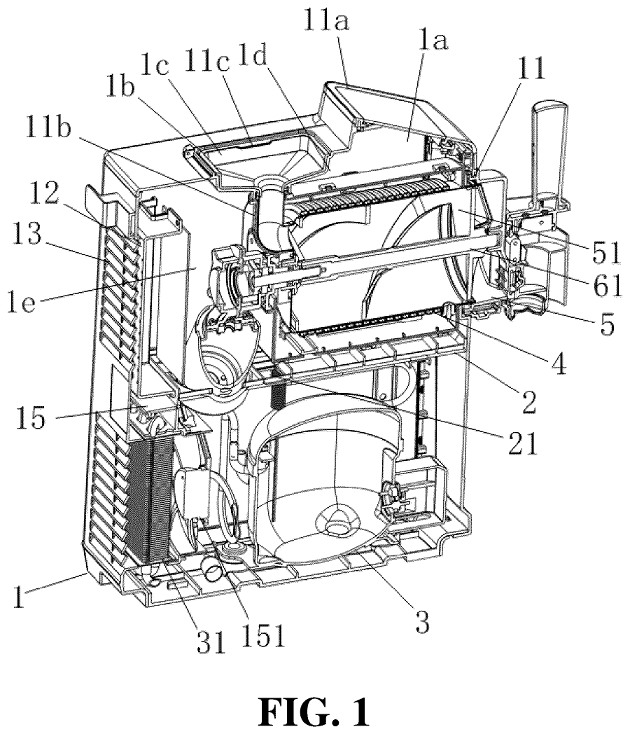

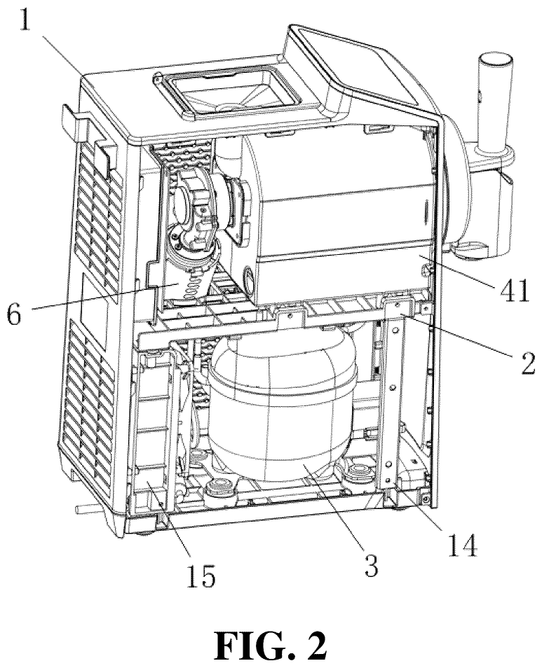

Referring to FIG. 1 and FIG. 2, an embodiment of the present disclosure provides a cold beverage maker, including a cabinet 1, a separation plate 2 provided in the cabinet 1, a cold beverage apparatus for making a cold beverage, and a compressor 3 for refrigerating the cold beverage apparatus. Through the separation plate 2, the cabinet 1 is internally separated into an upper device space and a lower device space. The cold beverage apparatus and the compressor 3 are respectively provided in the upper device space and the lower device space.

The cold beverage apparatus includes an evaporator 4, a cold beverage cartridge 5 provided in the evaporator 4, a stirring member 51 provided in the cold beverage cartridge 5, and a driving apparatus 6 for driving the stirring member 51.

A display region is provided on a front or a top of the cabinet 1. A feed region is provided on the top of the cabinet.

At the display region, the front or the top of the cabinet 1 inclines upward to form, in the cabinet 1, a display space 1a for mounting a display screen. A display port 11a for mounting a display panel is formed at the display region. In this way, when operated, the display panel mounted in the display port 11a can face a field of view (FoV) of the user to facilitate operation and observation of the display panel.

At the feed region, the top of the cabinet 1 is recessed to form a feed groove 1b. A detachable feed hopper 1c is provided in the feed groove 1b. The feed hopper 1c communicates with the cold beverage cartridge 5.

Specifically, the upper device space is laterally divided into a refrigerating space 1d and a driving heat dissipating space 1e. The evaporator 4 and the driving apparatus 6 are respectively provided in the refrigerating space 1d and the driving heat dissipating space 1e.

On the cabinet 1, a discharge hole 11 matching with the cold beverage cartridge 5 and an upper heat dissipating port 12 for dissipating heat are respectively formed at a left end and a right end of the upper device space. Preferably, the upper heat dissipating port 12 is provided with a heat dissipating plate 13. A plurality of heat dissipating channels are formed in the heat dissipating plate 13.

In order to make the structure in the cabinet 1 more compact and ensure certain heat dissipation performance, the separation plate 2 is provided with a communicating region for communicating the upper device space and the lower device space. A plurality of communicating holes 21 are formed in the communicating region. The communicating region corresponds to the driving heat dissipating space 1e.

Moreover, a bracket 14 for supporting the separation plate 2 and a heat exchanger housing 15 for mounting a heat exchanger are respectively provided at two inner sides of the lower device space. The bracket 14 and the heat exchanger housing 15 jointly support the separation plate 2.

The heat exchanger 31 provided for the compressor 3 is provided in the heat exchanger housing 15. A cooling fan 151 is further provided in the heat exchanger housing 15. The cooling fan 151 is located under the communicating region. Accordingly, a lower heat dissipating port corresponding to the heat exchanger housing 15 is formed in the cabinet 1. The lower heat dissipating port is also provided with the heat dissipating plate 13.

Based on the communicating holes 21, when the cooling fan 151 under the communicating region exhausts gas and dissipates heat to the lower heat dissipating port, air in the upper device space flows to the lower device space and is exhausted from the lower heat dissipating port. Heat in the lower device space flows to the upper device space difficultly. Under a negative pressure, outside air flows to the driving heat dissipating space 1e from the upper heat dissipating port 12 to cool the apparatus in the driving heat dissipating space 1e. Hence, an electrical control component can be provided in the driving heat dissipating space 1e. Therefore, with only one small cooling fan 151 in the cabinet 1, heat in the upper device space and the lower device space can be dissipated, thereby making the structure in the cabinet 1 compact.

In order to detach the feed hopper 1c conveniently, a communicating tube 11b communicating with the cold beverage cartridge 5 is provided on a bottom of the feed groove 1b. The feed hopper 1c matches with the feed groove 1b in shape, so as to cover a surface of the feed groove 1b.

A lifting edge 11c for allowing a hand to lift is provided on an inner sidewall of the feed hopper 1c, so as to take out the feed hopper 1c from the feed groove 1b.

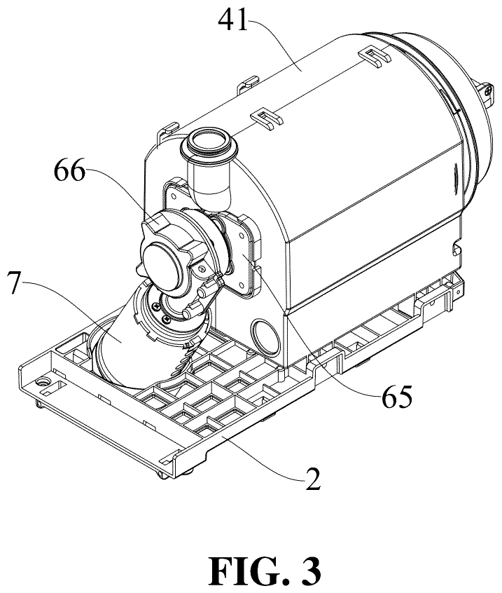

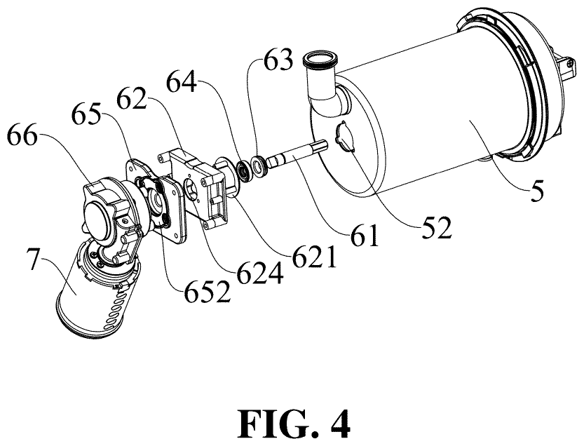

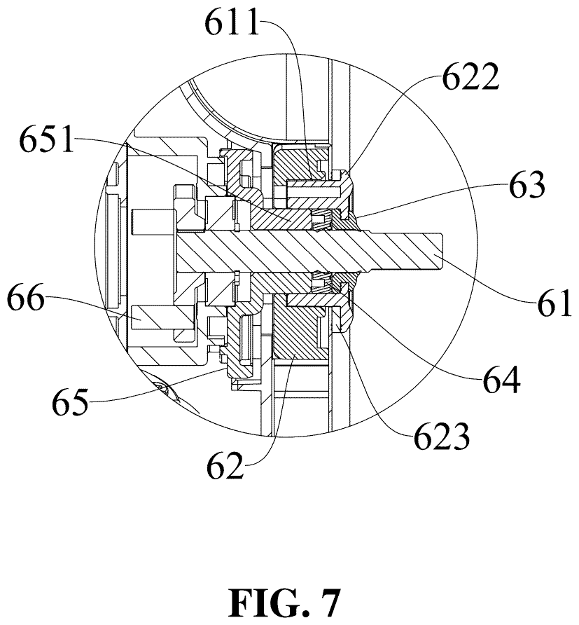

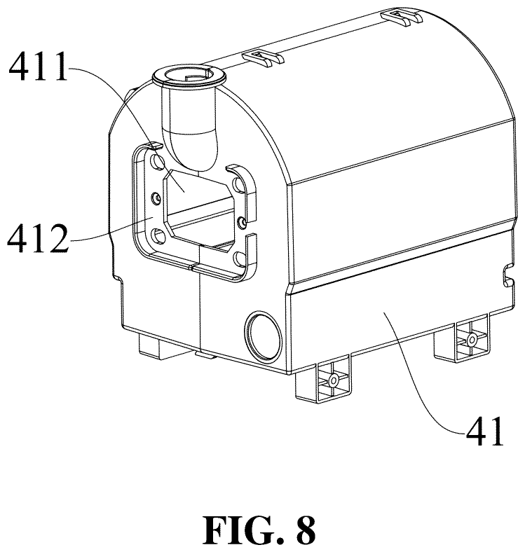

Referring to FIGS. 3-8, the driving apparatus 6 includes a rotating shaft 61 for driving the stirring member 51 to rotate and a first sealing connection seat 62.

The evaporator 4 is provided with an insulating housing 41. A first mounting hole 411 is formed in a sidewall of the insulating housing 41. The cold beverage cartridge 5 is mounted in the insulating housing 41. A second mounting hole 52 is formed in the cold beverage cartridge 5. The rotating shaft 61 rotatably penetrates through the second mounting hole 52 and the first mounting hole 411. The first sealing connection seat 62 is connected between the insulating housing 41 and the cold beverage cartridge 5. The first sealing connection seat 62 is connected to a limiting member 621. The limiting member 621 is inserted into the second mounting hole 52. The limiting member 621 is in sealing connection with the second mounting hole 52. The rotating shaft 61 penetrates through the limiting member 621. A first sealing member 63 is provided between the rotating shaft 61 and the limiting member 621. The first sealing member 63 includes an inner ring in sealing connection with the rotating shaft 61, and an outer ring in clearance fit with the limiting member 621.

Because of the clearance fit between the outer ring of the first sealing member 63 and the limiting member 621, in rotation of the rotating shaft 61, the rotating shaft 61 can be in movable sealing connection with the first sealing connection seat 62 and the limiting member 621 through the first sealing member 63. This reduces the wear extent to the first sealing member 63 for wear of the rotating shaft 61, prolongs the service life of the first sealing member 63, and ensures sealing performance between the rotating shaft 61 and the first sealing connection seat 62, thereby effectively lowering a leakage risk of liquid water of the cold beverage cartridge 5, and ensuring an ice-making rate of the liquid water of the cold beverage maker.

It is to be noted that the first sealing member 63 is preferably made of a wear-resistant and corrosion-resistant material such as polytetrafluoroethylene (PTFE) or rubber to prevent wear or corrosion of the first sealing member 63 in longtime use.

In the embodiment, the first sealing connection seat 62 can be limited in the second mounting hole 52 of the cold beverage cartridge 5 through the limiting member 621, and sealing performance between the first sealing connection seat 62 and the cold beverage cartridge 5 is ensured with sealing connection between the limiting member 621 and a sidewall of the second mounting hole 52.

In order to ensure sealing fit between the limiting member 621 and the second mounting hole 52, as shown in FIG. 3 to FIG. 5, an end of the limiting member 621 inserted into the second mounting hole 52 is provided with an extended boss 622. The extended boss 622 includes an outer ring abutting against an inner sidewall of the cold beverage cartridge 5 through a sealing gasket 623 in a sealing manner, and an inner ring connected to the outer ring of the first sealing member 63, so as to ensure that the first sealing member 63 is limited in the rotating shaft 61 through the limiting member 621. The sealing gasket 623 can cause deformation under a pressure to adaptively fill up a gap between connecting surfaces. The sealing gasket 623 is used to adapt to an abutment gap between the extended boss 622 of the limiting member 621 and the inner sidewall of the cold beverage cartridge 5 to realize sealing contact between the limiting member 621 and the inner wall of the cold beverage cartridge 5. This prevents leakage of liquid in the cold beverage cartridge 5 from an abutment position between the limiting member 621 and the inner wall of the cold beverage cartridge 5, and further lowers the leakage risk of the liquid water in the cold beverage cartridge 5.

Optionally, the limiting member 621 is made of an elastic material such as rubber. After the limiting member 621 is inserted into the second mounting hole 52, a sidewall of the limiting member 621 is rebound and closely abuts against the sidewall of the second mounting hole 52 to further enhance sealing performance between the limiting member 621 and the cold beverage cartridge 5.

Certainly, the limiting member 621 is not limited to the elastic material such as the rubber, and may also be made of a hard material. When the limiting member 621 is made of the hard material, the limiting member 621 is detachably connected to the first sealing connection seat 62 to ensure ease of assembly between the limiting member 621 and the first sealing connection seat 62.

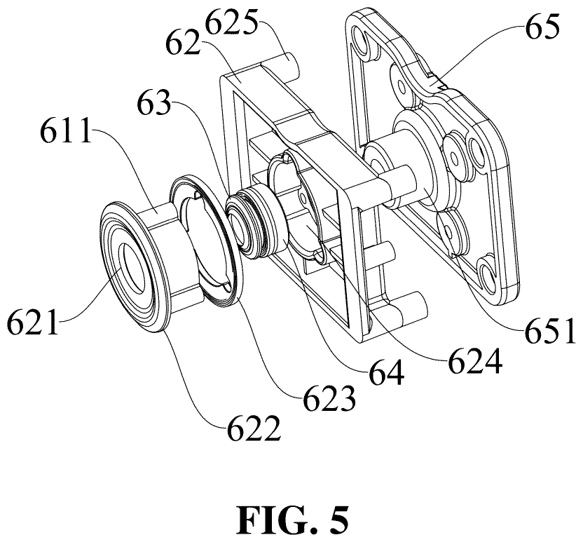

Specifically, as shown in FIG. 3 and FIG. 5, the limiting member 621 is provided with a connecting post 611. A plurality of threaded holes are formed in the connecting post 611 at intervals. A plurality of connecting holes are formed in the first sealing connection seat 62. When the first sealing connection seat 62 and the limiting member 621 are assembled to the cold beverage cartridge 5, the connecting post 611 of the limiting member 621 may penetrate through the second mounting hole 52, and the first sealing connection seat 62 and the limiting member 621 are connected through a bolt or a stud, thereby ensuring ease of assembly between the limiting member 621 and the first sealing connection seat 62.

Further, a side of the first sealing member 63 away from the cold beverage cartridge 5 is provided with a second sealing member 64. The second sealing member 64 includes an inner ring in sealing connection with the rotating shaft 61, and an outer ring abutting against the limiting member 621. The second sealing member 64 is used to further reduce the connecting gap between the limiting member 621 and the rotating shaft 61, thereby further enhancing sealing performance between the rotating shaft 61 and the limiting member 621.

Specifically, the inner ring of the second sealing member 64 is provided with a seal lip. A section of the seal lip is an oblique plane. Through the second sealing member 64, an oil seal is formed between the rotating shaft 61 and the limiting member 621 as well as between the rotating shaft and the first sealing connection seat 62. Through cooperation between the second sealing member 64 and the first sealing member 63, stable and reliable sealing performance is provided for the rotating shaft 61, the limiting member 621 and the first sealing connection seat 62.

In the embodiment, in order to ensure mounting stability of the first sealing connection seat 62, the first sealing connection seat 62 has a preset height. A distance between an inner side of the insulating housing 41 and an outer side of the cold beverage cartridge 5 is the same as the preset height. When the first sealing connection seat 62 is assembled between the insulating housing 41 and the cold beverage cartridge 5, the first sealing connection seat 62 can be clamped by the inner side of the insulating housing 41 and the outer wall of the cold beverage cartridge 5, and the first sealing connection seat 62 is connected by the limiting member 621 penetrating through the second mounting hole 52. This ensures assembly stability of the first sealing connection seat 62 between the insulating housing 41 and the cold beverage cartridge 5, and prevents the first sealing connection seat 62 from shaking to affect the sealing performance of the first sealing member 63.

In the embodiment, as shown in FIG. 2 to FIG. 5, the driving apparatus 6 further includes a second sealing connection seat 65. The second sealing connection seat 65 is provided on an outer sidewall of the insulating housing 41. The second sealing connection seat 65 is detachably connected to the first sealing connection seat 62. A size of the second sealing connection seat 65 is greater than a size of the first mounting hole 411. When the second sealing connection seat 65 is connected to the outer sidewall of the insulating housing 41, the second sealing connection seat 65 can shield the first mounting hole 411 to prevent an internal component of the insulating housing 41 from being exposed, and realize dust prevention for the insulating housing 41.

It is to be noted that in order to detachably connect the first sealing connection seat 62 and the second sealing connection seat 65, and connect the first sealing connection seat 62 and the second sealing connection seat 65 to form a whole sealing apparatus, a side of the first sealing connection seat 62 away from the cold beverage cartridge 5 is provided with a connecting boss 625, and a connecting hole is formed in the second sealing connection seat 65. When the first sealing connection seat 62 and the second sealing connection seat 65 are assembled, the connecting boss 625 of the first sealing connection seat 62 penetrates through a mounting hole in the sidewall of the insulating housing 41, and the first sealing connection seat 62 and the second sealing connection seat 65 are threadedly connected with a bolt or a stud.

Further, as shown in FIG. 3 to FIG. 5, a side of the second sealing connection seat 65 close to the first sealing connection seat 62 is provided with a sealing boss 651. An insertion hole 624 is formed in the first sealing connection seat 62. The sealing boss 651 is inserted into the insertion hole 624. An inner side of the sealing boss 651 abuts against the second sealing member 64. With sealing contact between the inner side of the sealing boss 651 and the second sealing member 64, sealing connection is formed at a junction between the first sealing connection seat 62 and the second sealing connection seat 65, and the second sealing member 64 is limited axially. This further ensures sealing performance of the second sealing member 64 for the first sealing connection seat 62 and the second sealing connection seat 65.

It is to be noted that in the embodiment, the insertion hole 624 is coaxial with the first mounting hole 411 and the second mounting hole 52. A hollow hole is formed in the sealing boss 651. The rotating shaft 61 is rotatably connected to the hollow hole. The sealing boss 651 of the second sealing connection seat 65 is used to limit and protect the rotating shaft 61 to further ensure rotational stability of the rotating shaft 61.

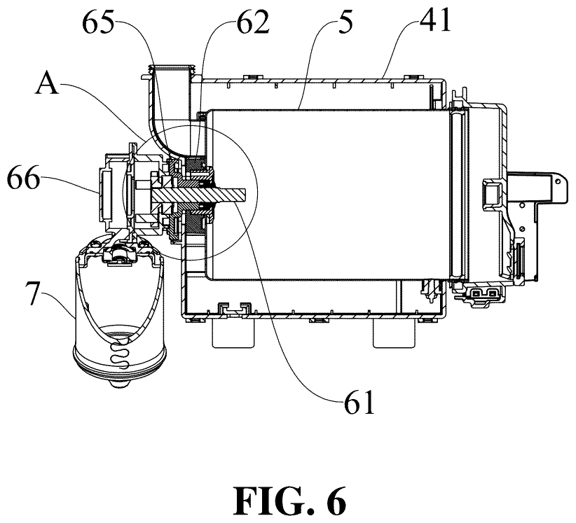

As shown in FIG. 6, a first mounting groove 412 is formed in the outer sidewall of the insulating housing 41. The second sealing connection seat 65 is embedded into the first mounting groove 412. The outer sidewall of the second sealing connection seat 65 is limited and fixed by the first mounting groove 412 to further ensure stability of the second sealing connection seat 65 on the insulating housing 41.

In the embodiment of the present disclosure, as shown in FIG. 1 and FIG. 2, the driving apparatus 6 further includes a driving connection seat 66. The driving connection seat 66 includes one side connected to the second sealing connection seat 65, and the other side connected to a driving member 7. A transmission set (not shown in the figure) is provided in the driving connection seat 66. An output shaft of the driving member 7 is rotatably connected to a driving end of the transmission set. A driven end of the transmission set is rotatably connected to the rotating shaft 61. The driving member 7 can drive the driving end of the transmission set to rotate, thereby driving the driven end of the transmission set and the rotating shaft 61 to rotate. Therefore, the rotating shaft 61 can drive a stirring structure in the cold beverage cartridge 5 to rotate, thereby realizing transmission of ice chunks in the cold beverage cartridge 5.

With dust prevention of the driving connection seat 66 for the transmission set as well as a junction between the transmission set and the driving member 7, and a junction between the transmission set and the rotating shaft 61, the driving member 7, the transmission set and the rotating shaft 61 cannot be directly exposed out in an external environment to ensure effective transmission among the driving member 7, the transmission set and the rotating shaft 61, and ensure a rate of energy utilization of the driving member 7.

It is to be noted that the driving connection seat 66 may include a first connection seat and a second connection seat that are detachably connected, so as to facilitate maintenance and repair of the transmission set in the driving connection seat 66. The first connection seat is connected to a housing of a drive motor, and the second connection seat is connected to the second sealing connection seat 65. A front end of the rotating shaft 61 is rotatably connected to the second connection seat through a bearing to further ensure rotational stability of the rotating shaft 61.

It is further to be noted that the transmission set is preferably a gear set for transmission of the driving member 7 and the rotating shaft 61 to reduce a space occupied by the driving connection seat 66, and improve space utilization of a sealing connection component of a making housing. Certainly, the specific structure of the transmission set is not limited to the gear set, and may also be other transmission structures such as a chain transmission structure or a belt transmission structure. The specific structure of the transmission set may be set correspondingly according to an actual condition.

As shown in FIG. 2, a second mounting groove 652 is formed at a side of the second sealing connection seat 65 away from the insulating housing 41. One side of the driving connection seat 66 is embedded into the second mounting groove 652. The side of the second mounting groove 65 is limited and fixed by the second mounting groove 652 to ensure connection stability between the second sealing connection seat 65 and the driving connection seat 66.

It is to be noted that in order to further ensure connection stability between the driving connection seat 66 and the second sealing connection seat 65, a plurality of threaded countersinks are formed in the second mounting groove 651. A plurality of threaded holes are formed in the driving connection seat 66. When the side of the driving connection seat 66 is embedded into the second mounting groove 652, the threaded hole and the threaded countersink matching correspondingly are connected threadedly through a bolt or a stud to further improve the connection stability between the driving connection seat 66 and the second sealing connection seat 65.

Further, in order to increase a material buffering amount of the feed groove 1b, a rabbet of the feed groove 1b extends upward to form an extension edge of a preset length, thereby forming a guide channel housing communicating with the feed groove 1b. The guide channel housing is a tubular structure. The guide channel housing is provided with a cover to shield an upper port of the guide channel housing.

The cold beverage maker is an ice cream maker or a smoothie maker or a multifunctional machine for making ice cream and smoothie. That is, the cold beverage maker can be used to make ice cream or smoothie.

The descriptions above are preferred implementations of the present disclosure. It should be noted that for a person of ordinary skill in the art, various improvements and modifications can be made without departing from the principles of the present disclosure. These improvements and modifications should also be regarded as falling into the protection scope of the present disclosure.

1. A cold beverage maker, comprising a cabinet, a separation plate provided in the cabinet, a cold beverage apparatus for making a cold beverage, and a compressor for refrigerating the cold beverage apparatus, wherein through the separation plate, the cabinet is internally separated into an upper device space and a lower device space; and the cold beverage apparatus and the compressor are respectively provided in the upper device space and the lower device space;
the cold beverage apparatus comprises an evaporator, a cold beverage cartridge provided in the evaporator, a stirring member provided in the cold beverage cartridge, and a driving apparatus for driving the stirring member;
a display region is provided on a front or a top of the cabinet; and a feed region is provided on the top of the cabinet; and
at the feed region, the top of the cabinet is recessed to form a feed groove; a detachable feed hopper is provided in the feed groove; and the feed hopper communicates with the cold beverage cartridge.

2. The cold beverage maker according to claim 1, wherein at the display region, the front or the top of the cabinet inclines upward to form, in the cabinet, a display space for mounting a display screen; and a display port for mounting a display panel is formed at the display region.

3. The cold beverage maker according to claim 1, wherein the upper device space is laterally divided into a refrigerating space and a driving heat dissipating space; and the evaporator and the driving apparatus are respectively provided in the refrigerating space and the driving heat dissipating space; and
on the cabinet, a discharge hole matching with the cold beverage cartridge and an upper heat dissipating port for dissipating heat are respectively formed at a left end and a right end of the upper device space.

4. The cold beverage maker according to claim 3, wherein the separation plate is provided with a communicating region for communicating the upper device space and the lower device space; and a plurality of communicating holes are formed in the communicating region; and
the communicating region corresponds to the driving heat dissipating space.

5. The cold beverage maker according to claim 4, wherein a bracket for supporting the separation plate and a heat exchanger housing for mounting a heat exchanger are respectively provided at two inner sides of the lower device space; and
the bracket and the heat exchanger housing jointly support the separation plate.

6. The cold beverage maker according to claim 5, wherein the heat exchanger provided for the compressor is provided in the heat exchanger housing; a cooling fan is further provided in the heat exchanger housing; and the cooling fan is located under the communicating region.

7. The cold beverage maker according to claim 1, wherein a communicating tube communicating with the cold beverage cartridge is provided on a bottom of the feed groove; and
the feed hopper matches with the feed groove in shape, so as to cover a surface of the feed groove.

8. The cold beverage maker according to claim 1, wherein the evaporator is provided with an insulating housing; a first mounting hole is formed in a sidewall of the insulating housing; and the driving apparatus comprises a rotating shaft for driving the stirring member to rotate and a first sealing connection seat;
the cold beverage cartridge is mounted in the insulating housing; a second mounting hole is formed in the cold beverage cartridge; and the rotating shaft rotatably penetrates through the second mounting hole and the first mounting hole;
the first sealing connection seat is connected between the insulating housing and the cold beverage cartridge; the first sealing connection seat is connected to a limiting member; the limiting member is inserted into the second mounting hole; and the limiting member is in sealing connection with the second mounting hole; and
the rotating shaft penetrates through the limiting member; a first sealing member is provided between the rotating shaft and the limiting member; and the first sealing member comprises an inner ring in sealing connection with the rotating shaft, and an outer ring in clearance fit with the limiting member.

9. The cold beverage maker according to claim 8, wherein an end of the limiting member inserted into the second mounting hole is provided with an extended boss; and the extended boss comprises an outer ring abutting against an inner sidewall of the cold beverage cartridge through a sealing gasket in a sealing manner, and an inner ring connected to the outer ring of the first sealing member; and
a side of the first sealing member away from the cold beverage cartridge is provided with a second sealing member; and an inner ring of the second sealing member is in sealing connection with the rotating shaft.

10. The cold beverage maker according to claim 9, wherein the driving apparatus further comprises a second sealing connection seat provided on an outer sidewall of the insulating housing; the second sealing connection seat is detachably connected to the first sealing connection seat; and a size of the second sealing connection seat is greater than a size of the first mounting hole;
a side of the second sealing connection seat close to the first sealing connection seat is provided with a sealing boss; an insertion hole is formed in the first sealing connection seat; the sealing boss is inserted into the insertion hole; and an inner side of the sealing boss abuts against the second sealing member; and
a first mounting groove is formed in the outer sidewall of the insulating housing; and the second sealing connection seat is embedded into the first mounting groove.

11. The cold beverage maker according to claim 10, wherein the driving apparatus further comprises a driving connection seat; the driving connection seat comprises one side connected to the second sealing connection seat, and the other side connected to a driving member; a transmission set is provided in the driving connection seat; an output shaft of the driving member is rotatably connected to a driving end of the transmission set; and a driven end of the transmission set is rotatably connected to the rotating shaft; and
a second mounting groove is formed at a side of the second sealing connection seat away from the insulating housing; and one side of the driving connection seat is embedded into the second mounting groove.

12. The cold beverage maker according to claim 1, wherein a rabbet of the feed groove extends upward to form an extension edge of a preset length, thereby forming a guide channel housing communicating with the feed groove.

13. The cold beverage maker according to claim 1, wherein the cold beverage maker is an ice cream maker or a smoothie maker or a multifunctional machine for making ice cream and smoothie.
